(19) United States
(12) Patent Application Publication
(10) Pub. No.: US 2014/0067731 A1
(43) Pub. Date: Mar. 6, 2014

(54) MULTI-DIMENSIONAL INFORMATION ENTRY PREDICTION

(71) Applicant: Scott ADAMS, Pleasanton, CA (US)

(72) Inventor: Scott ADAMS, Pleasanton, CA (US)

(21) Appl. No.: 13/605,314

(22) Filed: Sep. 6, 2012

(51) Int. Cl. G06F 15/18

(52) U.S. Cl. 706/12

(57) ABSTRACT

Intended meanings of user input character strings having multiple interpretations and having a single intended meaning are predicted in real time as they are entered by applying a profile thereto. The profile is generated by application of unsupervised and supervised learning techniques which identify predictive factors. Substantially simultaneously with application of the profile to the character strings, a plurality of remotely located profiles are accessed. The remotely located profiles are determined by application of supervised and unsupervised techniques to a plurality of third parties and are identified and ranked to determine those profiles that most nearly match one or more predictive factors in the user profile, where the predictive factors are weighted based on the ranking, the weighted predictive factors are combined with the user profile to determine the intended meaning of the character string from among the multiple interpretations, and the intended meaning is displayed to the user.

### BACKGROUND OF THE INVENTION

1. Technical Field

The invention relates to information entry. More particularly, the invention relates to multi-dimensional information entry prediction.

2. Description of the Background Art

Autocomplete, or word completion, is a feature provided by many Web browsers, e-mail programs, search engine interfaces, source code editors, database query tools, word processors, and command line interpreters. Autocomplete is also available for, or already integrated in, general text editors. Autocomplete involves a program predicting a word or phrase that the user wants to type in without the user actually typing it in completely. This feature is effective when it is easy to predict the word being typed based on those words that have already been typed, such as when there are a limited number of possible or commonly used words, as is the case with e-mail programs, Web browsers, or command line interpreters; or when editing text written in a highly-structured, easy-to-predict language, as in source code editors. It can also be very useful in text editors, when the prediction is based on a list of words in one or more languages. For special purposes, such as medical or technical texts, a word list of terms in that field is used. Many autocomplete programs also learn new words after the user has written them a few times, and can suggest alternatives based on the habits of the individual user.

Autocomplete or word prediction is the provision of words that are frequently used in response to a user's keystrokes. The original purpose of word prediction software was to help people with physical disabilities increase their typing speed, as well as to help them decrease the number of keystrokes needed to complete a word or a sentence. The need to increase speed is noted by the fact that people who use speech generating devices generally produce speech at a rate that is less than 10% as fast as people who use oral speech. But the function is also very useful for anybody who writes text.

Autocomplete or word completion works so that when the writer writes the first letter or letters of a word, the program predicts one or more possible words as choices. If the word he intends to write is included in the list he can select it, for example by using the number keys. If the word that the user wants is not predicted, the writer must enter the next letter of the word. At this time, the word choice is altered so that the words provided begin with the same letters as those that have been selected. When the word that the user wants appears it is selected, and the word is inserted into the text.

In another form of word prediction, words most likely to follow the just written word are predicted based on recent word pairs used. Word prediction uses language modeling, where within a set vocabulary the words are most likely to occur are calculated. Along with language modeling, basic word prediction on augmentative and alternative communication (AAC) devices is often coupled with a recency model, where words that are used more frequently by the AAC user are more likely to be predicted. Word prediction software often also allows the user to enter their own words into the word prediction dictionaries either directly, or by learning words that have been written.

There are standalone tools that add autocomplete functionality to existing applications. These programs monitor user keystrokes and suggests a list of words based on first typed letters. Examples are Typingaid and Letmetype.

Shorthand, also called autoreplace, is a related feature that involves automatic replacement of a particular string with another one, usually one that is longer and harder to type, as “myname” with “Lee John Nikolai Francois Al Rahman.” This can also quietly fix simple typing errors, such as turning “teh” into “the.” Several autocomplete programs, standalone or integrated in text editors, based on word lists, also include a shorthand function for often used phrases.

Context completion is a text editor feature, similar to word completion, which completes words, or entire phrases, based on the current context and context of other similar words within the same document, or within some training data set. The main advantage of context completion is the ability to predict anticipated words more precisely and even with no initial letters. The main disadvantage is the need of a training data set, which is typically larger for context completion than for simpler word completion. Most common use of context completion is seen in advanced programming language editors, where training data set is inherently available and context completion makes more sense to the user than broad word completion would.

Line completion is a type of context completion. The context in line completion is the current line, while current document poses as training data set. When user begins a line which starts with a frequently-used phrase, the editor automatically completes it, up to the position where similar lines differ, or proposes a list of common continuations.

Although research has shown that word prediction software does decrease the number of keystrokes needed and improves the written productivity of children with disabilities, there are mixed results as to whether or not word prediction actually increases speed of output. It is thought that the reason why word prediction does not always increase the rate of text entry is because of the increased cognitive load and requirement to move eye gaze from the keyboard to the monitor. To reduce this cognitive load, parameters such as reducing the list to five likely words, and having a vertical layout of those words may be used. The vertical layout is meant to keep head and eye movements to a minimum, and also gives additional visual cues because the word length becomes apparent.

In Web browsers, autocomplete is done in the address bar, using items from the browser's history, and in text boxes on frequently used pages, such as a search engine's search box. Autocomplete for Web addresses is particularly convenient because the full addresses are often long and difficult to type correctly.

In e-mail programs autocomplete is typically used to fill in the e-mail addresses of the intended recipients. Generally, there are a small number of frequently used e-mail addresses, hence it is relatively easy to use autocomplete to select between them. As with Web addresses, e-mail addresses are often long, hence typing them completely is inconvenient.

In search engines, autocomplete user interface features provide users with suggested queries or results as they type their query in the search box. This is also commonly called autosuggest or incremental search. This type of search often relies on matching algorithms that forgive entry errors such as phonetic Soundex algorithms or the language independent Levenshtein algorithm.

In many word processing programs, autocompletion decreases the amount of time spent typing repetitive words and phrases. The source material for autocompletion is either gathered from the rest of the current document or from a list of common words defined by the user. Currently OpenOffice.org, StarOffice, Microsoft Office, and KOffice include support for this kind of autocompletion, as do advanced text editors such as Emacs and Vim.

Text replacement, Replace as you type, or AutoCorrect is a function commonly found in word processors such as Microsoft Word and programming for Apple Inc. products including the iPod, iPhone, and the iPad. It is similar to but not the same as autocomplete, word prediction, shorthand for phrases and such tools for easier and faster writing. Its principal purpose is as part of the spell checker to correct common spelling or typing errors, saving time for the user. It is also used to format text automatically or insert special characters by recognizing particular character usage, saving the user from having to use more tedious functions.

Additional options include recognizing words with two initial capital letters, e.g. “Example,” and correcting them, capitalizing the first letters of sentences, and correcting accidental use of caps lock, e.g. eXAMPLE.

The replacement list for text replacement can also be modified by the user, allowing the user to use shortcuts. If, for example, the user is writing an essay on the industrial revolution, a replacement key can be set up to replace the ‘word’ “ir” with “industrial revolution”, saving the user time whenever he wants to type it. For users with the patience, this facility can even be used to create a complete keyboard shorthand system, along lines similar to those of Dutton Speedwords, but with short forms instantly replaced by full forms.

In certain situations, automatic corrections can cause problems. This is particularly so in technical and scientific writing. For example, the biochemical cyclic adenosine monophosphate is commonly referred to as “cyclic AMP,” which in turn is abbreviated to “cAMP”. A text replacement function may regard this capitalization to be erroneous, and so change it to “Camp,” which in the context of biochemistry is incorrect. Older automatic-correction algorithms can cause problems even in nontechnical writing; the Cupertino effect was an example: “cooperation” which some dictionaries would not recognize unless hyphenated “co-operation” became “Cupertino.”

Predictive text is an input technology used where one key or button represents many letters, such as on mobile phones and in accessibility technologies. Each key press results in a prediction rather than repeatedly sequencing through the same group of letters it represents, in the same, invariable order. Predictive text could allow for an entire word to be input by single key press. Predictive text makes efficient use of fewer device keys to input writing into a text message, an e-mail, an address book, a calendar, and the like.

The most widely used, general, predictive text systems are T9, iTap, and LetterWise/WordWise. There are many unique ways to build a device that predicts text, but all predictive text systems have initial, linguistic settings that offer predictions that are re-prioritized to adapt to each user. This learning adapts, by way of the device memory, to a user's disambiguating feedback that results in corrective key presses, such as pressing a “next” key to get to the intention. Most predictive text systems have a user database to facilitate this process.

The choice of which predictive text system is the best to use involves matching the user's preferred interface style, the user's level of learned ability to operate predictive text software, and the user's efficiency goal. There are various levels of risk in predictive text systems, versus multi-tap systems, because the predicted text that is automatically written that provide the speed and mechanical efficiency benefit, could, if the user is not careful to review, result in transmitting misinformation. Predictive text systems take time to learn to use well, and so generally, a device's system has user options to set up the choice of multi-tap or of any one of several schools of predictive text methods. Short message service (SMS) permits a mobile phone user to send text messages, also called messages, SMSes, texts, and txts, as a short message. The most common system of SMS text input is referred to as “multi-tap.” Using multi-tap, a key is pressed multiple times to access the list of letters on that key. For instance, pressing the “2” key once displays an “a,” twice displays a “b” and three times displays a “c.” To enter two successive letters that are on the same key, the user must either pause or hit a “next” button. A user can type by pressing an alphanumeric keypad without looking at the electronic equipment display. Thus, multi-tap is easy to understand, and can be used without any visual feedback. However, multi-tap is not very efficient, requiring potentially many keystrokes to enter a single letter.

In ideal predictive text entry, all words used are in the dictionary, punctuation is ignored, no spelling mistakes are made, and no typing mistakes are made. The ideal dictionary would include all slang, proper nouns, abbreviations, urls, foreign-language words, and other user-unique words. This ideal circumstance gives predictive text software the reduction in the number of key strokes a user is required to enter a word. The user presses the number corresponding to each letter and, as long as the word exists in the predictive text dictionary, or is correctly disambiguated by non-dictionary systems, it will appear. For instance, pressing “4663” is typically disambiguated as the word “good,” provided that a linguistic database in English is currently in use, though alternatives such as home, hood, hoof are also valid disambiguations of the sequence of key strokes.

All predictive text systems requires a linguistic database for every supported input language. Traditional disambiguation works by referencing a dictionary of commonly used words.

In dictionary-based systems, as the user presses the number buttons, an algorithm searches the dictionary for a list of possible words that match the key press combination, and offers up the most probable choice. The user can then confirm the selection and move on, or use a key to cycle through the possible combinations.

A non-dictionary system constructs words and other sequences of letters from the statistics of word parts. To attempt predictions of the intended result of keystrokes not yet entered, disambiguation may be combined with a word completion facility.

Either system (disambiguation or predictive) may include a user database, which can be further classified as a learning system when words or phrases are entered into the user database without direct user intervention. The user database is for storing words or phrases which are not well-disambiguated by the pre-supplied database. Some disambiguation systems further attempt to correct spelling, format text or perform other automatic rewrites, with the risky effect of either enhancing or frustrating user efforts to enter text.

### SUMMARY OF THE INVENTION

An embodiment of the invention comprises an apparatus and/or computer implemented method that predicts intended meanings in real time from character strings that are input by a user and that have multiple interpretations. A processor receives a plurality of user inputs from an input device, such as a keyboard, touch or stylus text entry device, gesture responsive device, voice, or combination thereof. The user inputs initially comprise or are converted to character strings that have multiple interpretations as entered and that have a single intended meaning.

The processor applies a profile to the character strings to predict the intended meaning thereof. The processor generates the profile by application of an unsupervised learning technique in which user interaction and interaction context with the device are both observed and noted, and by application of a supervised learning technique comprising a processor implemented user survey, where the processor executes the survey locally at the device to generate the user profile and to store the user profile at the device.

The unsupervised and supervised learning techniques identify predictive factors comprising any two or more of: gender; education level; family and friends; occupation/industry; hobbies; intended audience/recipient; location; style; age; intelligence; favorite words often used; most often mistyped keys; and type and style of writing.

Substantially simultaneously with application of the profile to the character strings, the processor accesses a plurality of remotely located profiles in real time or otherwise, for example via a network, where the remotely located profiles are determined by application of supervised and unsupervised techniques to a plurality of third parties. The processor identifies and ranks the remotely located profiles to determine those profiles that most nearly match one or more predictive factors in the user profile, weighting the predictive factors based on the ranking, combining the weighted predictive factors with the user profile to determine the intended meaning of the character string from among the multiple interpretations, and displaying the intended meaning to the user. In an embodiment, those characters within the character string which have been determined by prediction are highlighted. A user can select a character string that contains highlighted characters and is presented with a ranked list of likely candidates. The user can select another of the candidates if the predicted interpretation initially presented to the user is not the user's intended meaning.

### BRIEF DESCRIPTION OF THE DRAWINGS

FIG. 1 is a block schematic diagram that shows a multi-dimensional word prediction architecture according to the invention;

FIG. 2 is a flow diagram that shows operation of a multi-dimensional word prediction architecture according to the invention; and

FIG. 3 is a block schematic diagram that depicts a machine in the exemplary form of a computer system within which a set of instructions for causing the machine to perform any of the herein disclosed methodologies may be executed.

### DETAILED DESCRIPTION OF THE INVENTION

An embodiment of the invention comprises an apparatus and/or computer implemented method that predicts intended meanings in real time from character strings that are input by a user and that have multiple interpretations. A processor receives a plurality of user inputs from an input device, such as a keyboard, touch or stylus text entry device, gesture responsive device, voice, or combination thereof. The user inputs initially comprise or are converted to character strings that have multiple interpretations as entered and that have a single intended meaning.

The processor applies a profile to the character strings to predict the intended meaning thereof. The processor generates the profile by application of an unsupervised learning technique in which user interaction and interaction context with the device are both observed and noted, and by application of a supervised learning technique comprising a processor implemented user survey, where the processor executes the survey locally at the device to generate the user profile and to store the user profile at the device.

The unsupervised and supervised learning techniques identify predictive factors comprising any two or more of: gender; education level; family and friends; occupation/industry; hobbies; intended audience/recipient; location; style; age; intelligence; favorite words often used; most often mistyped keys; and type and style of writing. For example, where a 12-year is typing “awe” the system recognizes that his age and gender means he probably intends the word “awesome,” while a 49-year old English professor probably intends the phrase “awe-inspiring.”

Substantially simultaneously with application of the profile to the character strings, the processor accesses a plurality of remotely located profiles in real time or otherwise, for example via a network, where the remotely located profiles are determined by application of supervised and unsupervised techniques to a plurality of third parties. The processor identifies and ranks the remotely located profiles to determine those profiles that most nearly match one or more predictive factors in the user profile, weighting the predictive factors based on the ranking, combining the weighted predictive factors with the user profile to determine the intended meaning of the character string from among the multiple interpretations, and displaying the intended meaning to the user. In an embodiment, those characters within the character string which have been determined by prediction are highlighted. A user can select a character string that contains highlighted characters and is presented with a ranked list of likely candidates. The user can select another of the candidates if the predicted interpretation initially presented to the user is not the user's intended meaning.

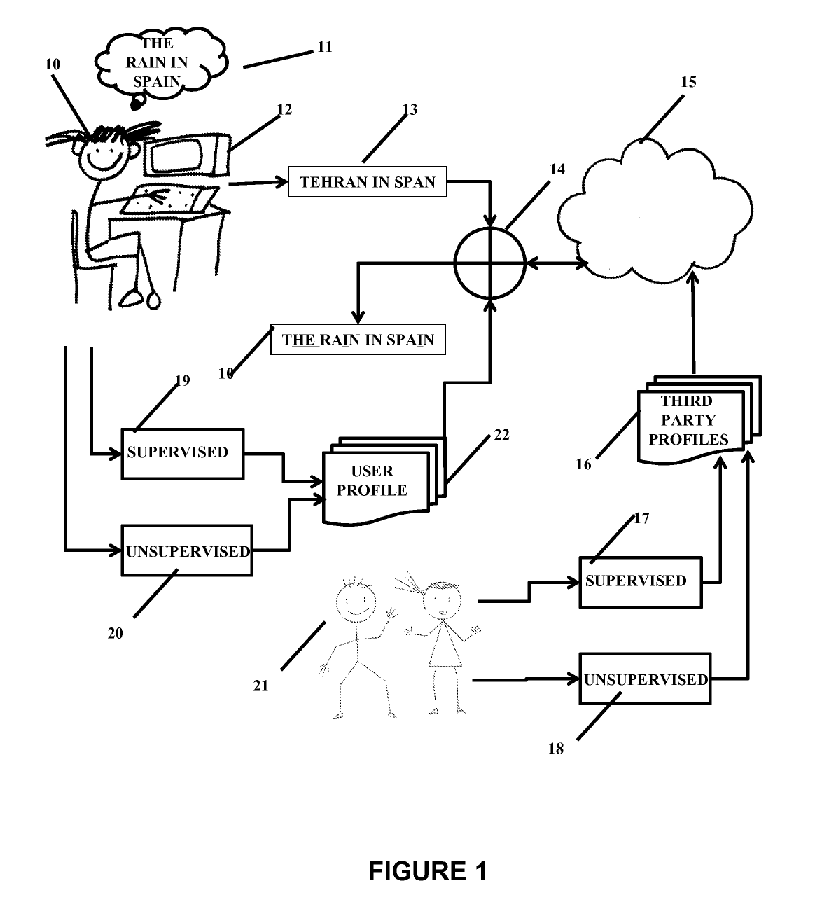

FIG. 1 is a block schematic diagram that shows a multi-dimensional word prediction architecture according to the invention. In FIG. 1, a user 10 uses a display and information entry device 12 to enter an intended phrase 11, i.e. THE RAIN IN SPAIN. Such entry comprises, in an embodiment, a string of text characters although, in other embodiments, the phrase may be entered as speech, gestures, or any combination of characters, speech, and gestures.

The user entry is subject to many interpretations in addition to the user's intended interpretation. In the example of FIG. 1, the phrase is entered as TEHRAN IN SPAN 13.

The string of characters entered by the user is provided to a processor 14. The processor accesses a user profile 22 to generate a predicted intended meaning for the string of characters, based upon profile information derived from supervised 19 and unsupervised 20 interactions between the user and the user's information entry device.

Substantially simultaneously with access to the user profile, the processor also accesses a plurality of remote profiles 16, for example via the Internet 15. The remote profiles are generated by third parties 21, based upon supervised 17 and unsupervised 18 interaction between the third parties and their respective information entry devices. The remote profiles may be accessed in real time via a network, they may be periodically accessed via a synchronization routine and cached locally, or they may be accessed by either mechanism depending upon device state, e.g. if a wireless connection is available they are accessed via the network, if a wireless connection is not available, local cached versions of the remote profiles are accessed.

For purposes of the discussion herein, information entry devices may be any device that is capable of receiving user inputs in any form, and that provides a processor and storage medium for processing and storing user inputs in accordance with the invention.

The processor uses the third party profiles and user profile together to predict the intended meaning of the phrase entered by the user and outputs same 18 for display to the user on the user's information entry device, or on another display device of the user's choosing. The output preferably is marked to show the user the alterations made by the prediction procedure to the user's original inputs. IN the example of FIG. 1, the output displayed to the user is THE RAIN IN SPAIN. The highlighting of predictions allows the user to determine if the predicted intended meaning matches the actual intended meaning of the user input before, for example, the user makes use of the text, for example before the user sends the text in an email or text message. In some embodiments, the user can tap on or otherwise select text that includes highlighted characters, in which case the system returns a ranked list of candidate words to the user. The user may then select an alternate word from the list to that which was presented to the user initially, if such word was not the word intended by the user. The system makes note of any such selection, updates the user profile, and in some embodiments, provides such information to remote profiles for use as a remote profile that is accessed by third parties who use the invention.

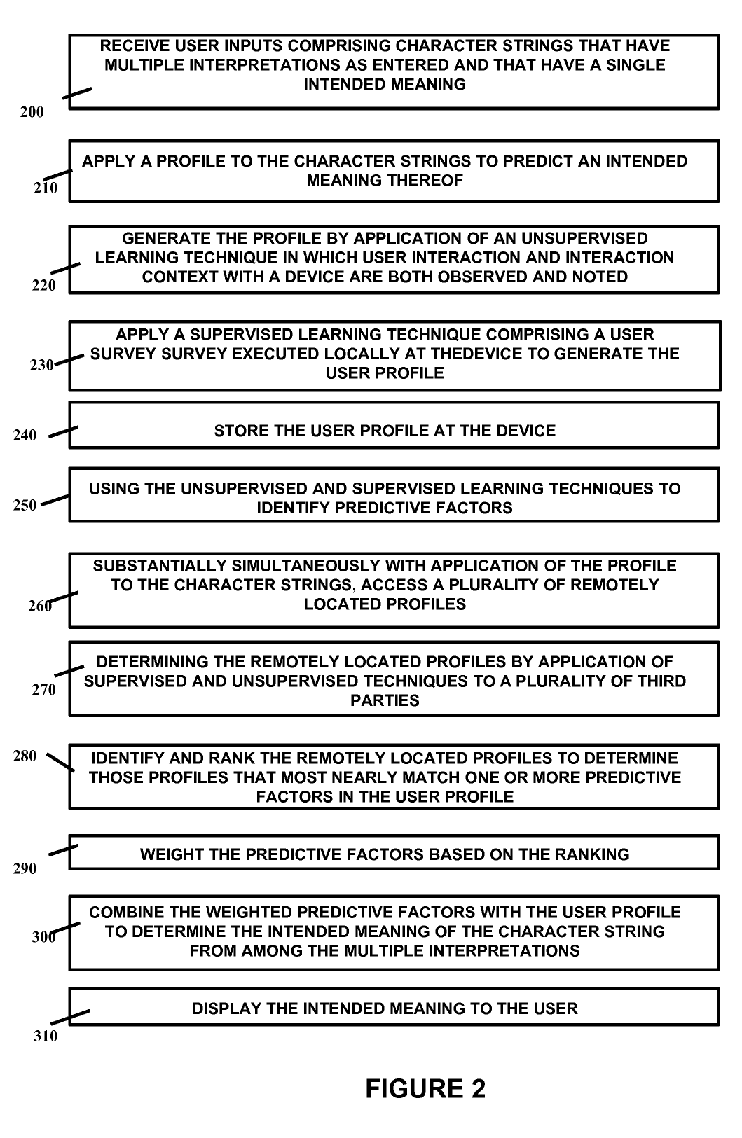

FIG. 2 is a flow diagram that shows operation of a multi-dimensional word prediction architecture according to the invention. In FIG. 2, the information input device receives user inputs that comprise character strings that have multiple interpretations as entered and that have a single intended meaning (200). If the user input is a gesture or voice-based, a facility is provided (not shown) for converting such inputs into character strings. While the discussion herein concerns character strings comprised of Latin characters, those skilled in the art will appreciate that the invention likewise applies to ideographic and other representational systems.

The processor applies a user profile to the character strings to predict an intended meaning thereof (210).

The processor generates the user profile by application of an unsupervised learning technique in which user interaction and interaction context with the information input device are both observed and noted (220). For example, if the user consistently corrects certain misspelled words, then the profile learns this and uses the previous corrections to address future misspellings; if the user exhibits different information entry behavior in different device contexts, such as during browsing or during the composition of a text message, then the profile reflects this context driven behavior. Factors that are considered in this regard, as noted above, can include for example gender; education level; family and friends; occupation/industry; hobbies; intended audience/recipient; location; style; age; intelligence; favorite words often used; most often mistyped keys; and type and style of writing. Other factors may also be considered, the foregoing list is not exhaustive. However, it is important that more than one factor be taken into account to provide more accurate prediction of the user's intended meaning.

In this regard, the processor also applies a supervised learning technique that, in an embodiment, comprises a survey that is executed locally at the user's information entry device. The survey may be taken by the user from any location, but the survey results are stored in the user profile with the unsupervised user profile information (240) and the results of the supervised and unsupervised learning techniques are applied via the user profile to identify predictive factors to apply to the input character string, for example (250).

Substantially simultaneously with application of the user profile to the character strings by the processor, the processor also uses the user information input device, or other suitable mechanism, to access a plurality of remotely located profiles (260). The remotely located profiles may be accessed, for example via a network, such as the Internet, in real time; or they may be downloaded to the device, for example during a synchronization routine, and accessed locally. Context may also determine when the remote profiles are accessed via a network, for example when a network is available, and when they are accessed as locally cached files, for example when a network is not available. Further, such synchronization routine can be used to upload user profile information into a remote profile repository for use by third parties in a remote profile that is accessed by such third parties who use the invention on their devices.

The remotely located profiles are determined by application of supervised and unsupervised techniques to information obtained from a plurality of third parties (270).

The most relevant remotely located profiles are identified and ranked by the processor to determine those profiles that most nearly match on or more predictive factors in the user profile (280). In this way, the user's behaviors are placed within those of a larger community, where similar behaviors and predictions for such behaviors are used to take advantage of the community experience.

The predictive factors are weighted based on the ranking (290), and the weighted predictive factors are combined with the user profile to determine the intended meaning of the character string (300).

Thereafter, the intended meaning is displayed to the user (310), all of the foregoing having taken place in near real time. Thus, it appears to the user the predictions are made as information is entered.

Computer Implementation

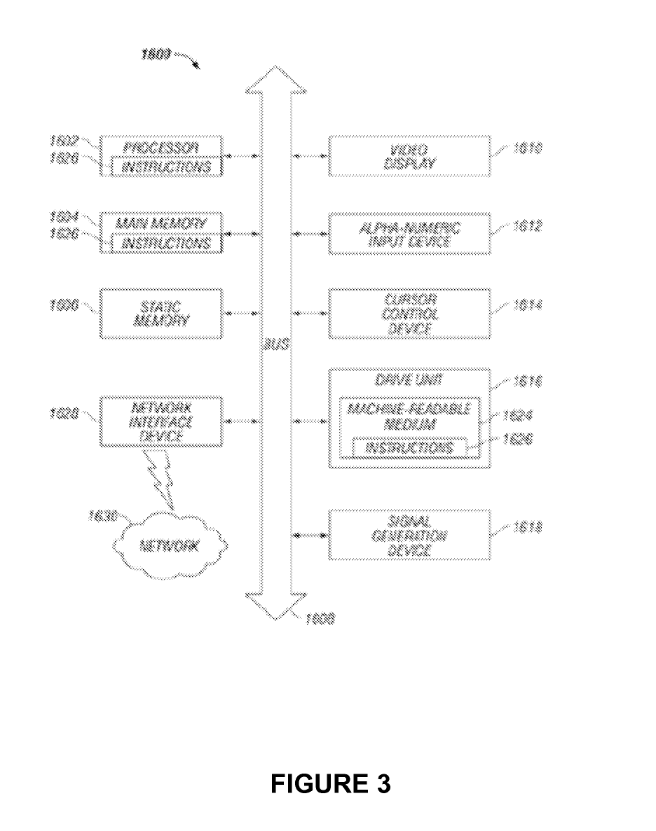

FIG. 3 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for predicting intended meanings in real time from input character strings that have multiple interpretations, comprising:
providing a processor for receiving a plurality of user inputs from an input device, said user inputs comprising character strings that have multiple interpretations as entered and that have a single intended meaning;
said processor applying a profile to said character strings to predict said intended meaning thereof;
said processor generating said profile by application of an unsupervised learning technique in which user interaction and interaction context with said device are both observed and noted, and by application of a supervised learning technique comprising a processor implemented user survey, said processor executing said survey locally at said device to generate said user profile and to store said user profile at said device;
said unsupervised and supervised learning techniques identifying and applying at least two predictive factors; and
substantially simultaneously with application of said profile to said character strings, said processor accessing a plurality of remotely located profiles via a network, said remotely located profiles being determined by application of supervised and unsupervised techniques to a plurality of third parties; and
said processor identifying and ranking said remotely located profiles to determine those profiles that most nearly match one or more predictive factors in said user profile, weighting said predictive factors based on said ranking, combining said weighted predictive factors with said user profile to determine the intended meaning of said character string from among said multiple interpretations, and displaying said intended meaning to said user with those characters within said character string which have been determined by prediction highlighted.

2. The method of claim 1, said at least two predictive factors comprising any two or more of:
gender;
education level;
family and friends;
occupation/industry;
hobbies;
intended audience/recipient;
location;
style;
age;
intelligence;
favorite words often used;
most often mistyped keys; and
type and style of writing.

3. The method of claim 1, wherein said input device comprises any of a keyboard, touch or stylus text entry device, gesture responsive device, voice responsive device, or combination thereof.

4. The method of claim 1, said processor configured for user selection of a character string that contains highlighted characters and, in response to such selection, presenting said user with a ranked list of likely candidates from which said user can select the user's intended meaning if a predicted interpretation initially presented to the user is not the user's intended meaning.

5. The method of claim 4, said processor configured to capture said user selection and update said user's profile.

6. The method of claim 4, said processor configured to provide said user selection information as a remote profile that is accessible by third parties.

7. An apparatus for predicting intended meanings in real time from input character strings that have multiple interpretations, comprising:
a processor configured for receiving a plurality of user inputs from an input device, said user inputs comprising character strings that have multiple interpretations as entered and that have a single intended meaning;
said processor configured for applying a profile to said character strings to predict said intended meaning thereof;
said processor configured for generating said profile by application of an unsupervised learning technique in which user interaction and interaction context with said device are both observed and noted, and by application of a supervised learning technique comprising a processor implemented user survey, said processor executing said survey locally at said device to generate said user profile and to store said user profile at said device;
said unsupervised and supervised learning techniques identifying and applying at least two predictive factors; and
said processor configured for, substantially simultaneously with application of said profile to said character strings, accessing a plurality of remotely located profiles via a network, said remotely located profiles being determined by application of supervised and unsupervised techniques to a plurality of third parties; and
said processor configured for identifying and ranking said remotely located profiles to determine those profiles that most nearly match one or more predictive factors in said user profile, weighting said predictive factors based on said ranking, combining said weighted predictive factors with said user profile to determine the intended meaning of said character string from among said multiple interpretations, and displaying said intended meaning to said user with those characters within said character string which have been determined by prediction highlighted.

8. The apparatus of claim 7, said at least two predictive factors comprising any two or more of:
gender;
education level;
family and friends;
occupation/industry;
hobbies;
intended audience/recipient;
location;
style;
age;
intelligence;
favorite words often used;
most often mistyped keys; and
type and style of writing.

9. The apparatus of claim 7, wherein said input device comprises any of a keyboard, touch or stylus text entry device, gesture responsive device, voice responsive device, or combination thereof.

10. The apparatus of claim 7, said processor configured for user selection of a character string that contains highlighted characters and, in response to such selection, presenting said user with a ranked list of likely candidates from which said user can select the user's intended meaning if a predicted interpretation initially presented to the user is not the user's intended meaning.

11. The apparatus of claim 10, said processor configured to capture said user selection and update said user's profile.

12. The apparatus of claim 10, said processor configured to provide said user selection information as a remote profile that is accessible by third parties.
